(19) United States
(12) Patent Application Publication
(10) Pub. No.: US 2025/0282141 A1
(43) Pub. Date: Sep. 11, 2025

(54) LIQUID APPLICATION APPARATUS

(71) Applicant: Satoshi KUNIOKA, Kanagawa (JP)

(72) Inventor: Satoshi KUNIOKA, Kanagawa (JP)

(21) Appl. No.: 19/070,552

(22) Filed: Mar. 5, 2025

(30) Foreign Application Priority Data
Mar. 11, 2024 (JP) 2024-036997

(51) Int. Cl. B41J 2/165; B41J 3/36; B41J 25/00; B62B 3/04; B62B 3/10; G06K 15/02; G06K 15/10

(52) U.S. Cl. CPC B41J 2/16511; B41J 3/36; B41J 25/001; B62B 3/04; B62B 3/10; B62B 2203/10; G06K 15/102; G06K 15/1848

(57) ABSTRACT

A liquid application apparatus includes a body; a head in the body, the head to discharge a liquid from a nozzle; a carriage movable between a first position and a second position; a base; a plate slidable on a horizontal plane; a cap on the plate, the cap to cap the nozzle of the head; a first mover to move the carriage, to the first position above the cap, on the horizontal plane; a second mover to move the carriage to the cap in a vertical direction; a cleaner on the plate, the cleaner to discharge a cleaning liquid onto the nozzles at the second position; and a guide to slide the plate relative to the base on the horizontal plane to guide the cap to the carriage at the first position when the second mover moves the carriage to the cap in the vertical direction.

### CROSS-REFERENCE TO RELATED APPLICATIONS

This patent application is based on and claims priority pursuant to 35 U.S.C. § 119(a) to Japanese Patent Application No. 2024-036997, filed on Mar. 11, 2024, in the Japan Patent Office, the entire disclosure of which is hereby incorporated by reference herein.

### BACKGROUND

### Technical Field

Embodiments of the present disclosure relate to a liquid application apparatus.

### Related Art

In an ink jet apparatus or an image forming apparatus (or an apparatus that discharges liquid) that forms an image by discharging liquid such as ink, techniques for adjusting the position of a cleaning mechanism relative to a discharge head are known.

### SUMMARY

An embodiment of the present disclosure provides liquid application apparatus including a body; a head in the body, the head to discharge a liquid from a nozzle; a carriage holding the head and movable between a first position and a second position; a base fixed to the body; a plate over the base and slidable on a horizontal plane parallel to a top face of the base; a cap on the plate, the cap to cap the nozzle of the head; a first mover to move the carriage, to the first position above the cap, on the horizontal plane; a second mover to move the carriage to the cap in a vertical direction orthogonal to the horizontal plane; a cleaner on the plate, the cleaner to discharge a cleaning liquid onto the nozzles of the head on the carriage at the second position to clean the nozzle; and a guide to slide the plate relative to the base on the horizontal plane to guide the cap to the carriage at the first position when the second mover moves the carriage to the cap in the vertical direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an external appearance of an overall configuration of a liquid application apparatus;

FIG. 2 is a diagram illustrating a part of a liquid application apparatus, where a carriage can scan relative to a printing device;

FIG. 3 is a diagram illustrating a configuration of a moving mechanism of a carriage of a liquid application apparatus;

FIG. 4 is a diagram illustrating the operation of the liquid application apparatus when printing outside the scanning range of a carriage;

FIG. 5 is a diagram illustrating a liquid application apparatus being moved on a cart.

FIG. 6 is a diagram illustrating a printing device of a liquid application apparatus, placed on a printing surface after being unloaded from a cart;

FIG. 7 is a diagram of a hardware configuration of a liquid application apparatus;

FIGS. 8A and 8B are diagrams each illustrating a configuration of a maintenance mechanism of a liquid application apparatus;

FIG. 9 is an enlarged view of a stepped screw of a maintenance mechanism of a liquid application apparatus;

FIGS. 10A and 10B are diagram illustrating an operation of inserting a pin of a carriage into a hole in a maintenance mechanism of a liquid application apparatus;

FIGS. 11A, 11B, and 11C are diagrams for describing a cleaning operations of an ink discharge head of a liquid application apparatus;

FIGS. 12A, 12B, and 12C are diagrams for describing a cleaning operations of an ink discharge head of a liquid application apparatus;

FIG. 13 is a diagram illustrating a configuration of a moving mechanism of a carriage of a liquid application apparatus;

FIGS. 14A, 14B, and 14C are diagrams illustrating an operation of capping an ink discharge head in a liquid application apparatus; and

FIG. 15 is a diagram illustrating a configuration of a moving mechanism for a carriage in a liquid application apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An inkjet apparatus or an image forming apparatus (or an apparatus that discharges liquid) with such a cleaning mechanism includes a liquid discharge head having nozzles for discharging liquid on a nozzle surface, a wiping member for wiping the nozzle surface, a rotatable pressing member for pressing the wiping member against the nozzle surface, and a moving unit for performing a wiping operation of bringing the wiping member into contact with the nozzle surface and relatively moving the liquid discharge head and the wiping member.

Such an inkjet apparatus, however, faces the challenge of manually readjusting the position of the cleaning mechanism before printing when the relative position between the discharge head and the cleaning mechanism changes.

According to one aspect of the present disclosure, the position of the discharge head relative to the cleaning mechanism can be automatically adjusted to an appropriate position during cleaning, even if the relative position between the discharge head and the cleaning mechanism changes.

A liquid application apparatus according to an embodiment of the present disclosure will be described in detail with reference to the drawings. The present disclosure, however, is not limited to the following embodiment, and components of the following embodiment include components that may be easily conceived by those skilled in the art, components being substantially the same, and components being within equivalent ranges. Furthermore, various omissions, substitutions, changes, and combinations of the components can be made without departing from the gist of the following embodiment.

### Overview of Overall Configuration and Operation of Liquid Application Apparatus

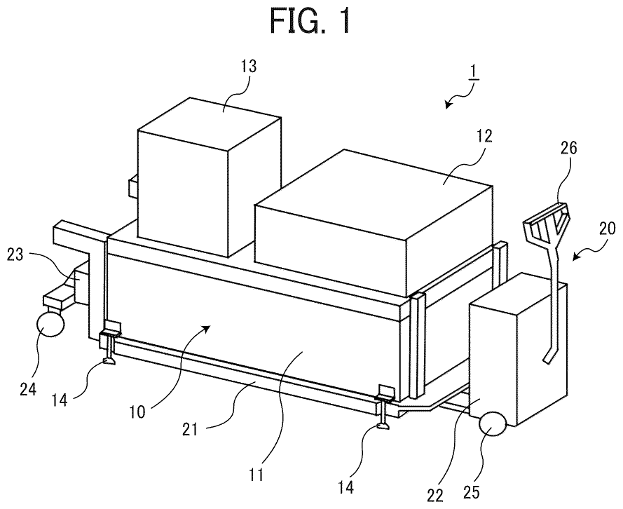

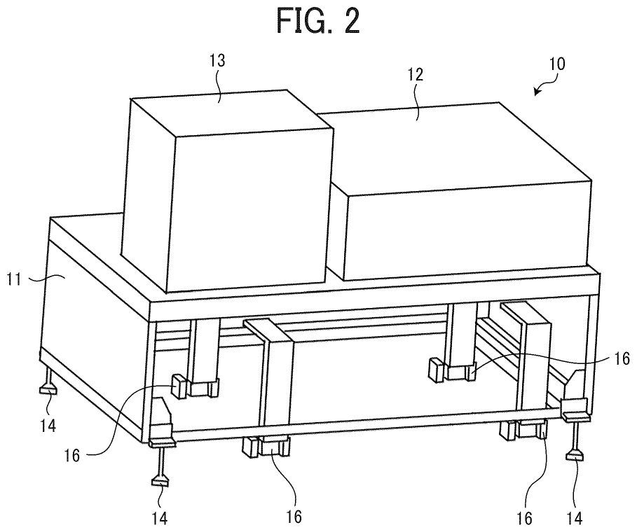

FIG. 1 is a diagram illustrating an external appearance of an overall configuration of a liquid application apparatus according to an embodiment of the present disclosure. FIG. 2 is a diagram illustrating a part of a liquid application apparatus according to an embodiment of the present disclosure, where a carriage can scan relative to a printing device.

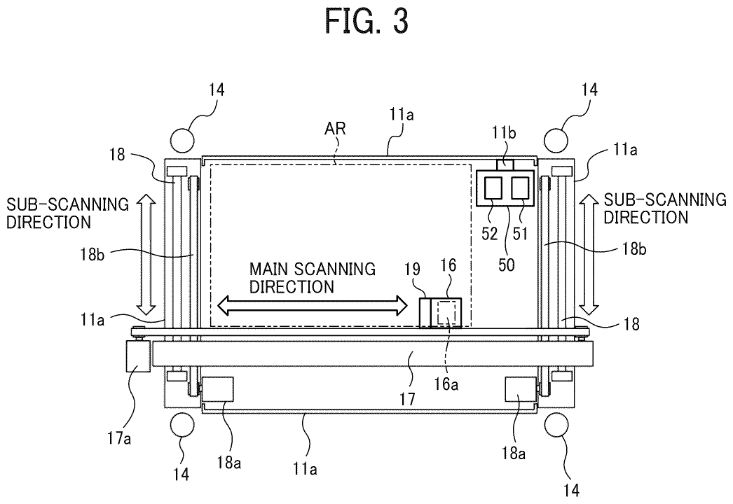

FIG. 3 is a diagram illustrating a configuration of a moving mechanism of a carriage of a liquid application apparatus according to an embodiment of the present disclosure. The overall configuration and operation of a liquid application apparatus I will be described with reference to FIGS. 1 to 3.

The liquid application apparatus 1 illustrated in FIG. 1 divides a wide liquid application area, such as a road surface, into multiple printing regions. The liquid application apparatus 1 then sequentially moves to each printing region, divides printing data for each printing region into multiple printing images, and discharges ink for printing. The ink is an example of liquid.

The road surface includes a road, a wall surface of a building. The road surface is simply referred to as a “printing surface”. Further, “printing” refers to an operation of forming an image by applying or spraying ink onto the installation surface.

FIG. 2 indicates the internal structure of a printing device 10 with a front-side panel removed. The front side refers to the side closer to the viewer in the drawing sheet (FIG. 2). As illustrated in FIG. 1, the liquid application apparatus 1 includes a printing device 10 and a cart 20.

The printing device 10 can be carried using the cart 20 and prints on the installation surface through the scanning of carriages 16 equipped with ink discharge heads 16a, as illustrated in FIG. 3. As illustrated in FIGS. 1 and 2, the printing device 10 includes a printing device body 11, a controller 12, an ink supply system 13, stands 14, and carriages 16.

As illustrated in FIG. 3, the printing device 10 includes a frame 11a, a main scanning guide 17, a main scanning motor 17a, a sub-scanning guide 18, a sub-scanning motor 18a, a timing belt 18b, and a height shifting mechanism 19. The printing device 10 serves as a moving mechanism for scanning the carriages 16 equipped with the ink discharge heads 16a.

The moving mechanism is supported by four stands 14 mounted on a frame 11a that forms the peripheral edge of the bottom surface of the printing device body 11. As illustrated in FIG. 3, the printing device 10 includes a support member 11b and a maintenance mechanism 50.

The printing device body 11 is a main body of the printing device 10, within which the carriages 16 scan in the main scanning direction and the sub-scanning direction orthogonal to the main scanning direction. Various components, such as the controller 12 and the ink supply system 13 are mounted on the upper surface of the printing device body 11. In FIG. 2, four carriages 16 are moved to the four corners of the rectangular area that allows the scanning of the carriages 16 within the interior of the printing device body 11.

The controller 12 controls the printing operation of the printing device 10. Specifically, the controller 12 controls scanning of the carriage 16 in the main scanning direction, the sub-scanning direction, and a height direction, an ink discharging operation of the ink discharge heads 16a mounted on the carriages 16, an ink supplying operation from the ink supply system 13 to the ink discharge heads 16a. The height direction is a vertical direction orthogonal to the main scanning direction and the sub-scanning direction, as well as the horizontal plane.

The controller 12 adjusts the height of each carriage 16 at multiple levels using the height shifting mechanism 19 to print images by discharging ink from the ink discharge heads 16a. To perform the maintenance operation of the maintenance mechanism 50 as described below, the controller 12 moves the carriages 16 in the height direction using the height shifting mechanism 19 so that the carriages 16 are positioned at a height for the maintenance operation.

The ink supply system 13 is mounted on the top surface of the printing device body 11 and supplies ink to the ink discharge heads 16a on the carriages 16. Specifically, the ink supply system 13 includes a tank for storing ink, and supplies ink from the tank to the ink discharge heads 16a of the carriages 16 through a supply path such as a tube.

The stands 14 are support members that are respectively mounted at the four corners of the bottom surface of the rectangular parallelepiped printing device body 1, supporting the printing device 10 by contacting the printing surface. The number of stands 14 is not limited to four, and may be three, five, or more.

As illustrated in FIG. 3, each carriage 16 is equipped with an ink discharge head 16a for ink discharge. The carriage 16 is scanned by the moving mechanism in the main scanning direction, the sub-scanning direction, and the height direction.

The scanning of the carriage 16 is controlled by the controller 12. To print images using the ink discharge heads 16a, the carriages 16 are moved in the main scanning direction and the sub-scanning direction within a printing area AR as illustrated in FIG. 3.

When not printing, the carriages 16 are moved to the maintenance mechanism 50 for the cleaning and capping operations, as illustrated in FIG. 3.

Each ink discharge head 16a is an ink jet discharge head. Each ink discharge head 16a has multiple nozzles for discharging ink.

The frame 11a is a frame member that forms four sides of the bottom surface of the printing device body 11. As illustrated in FIG. 3, the stands 14 are mounted at the four corners of the bottom surface of the printing device body 11, the four sides of which are formed by the frame 11a.

The main scanning guide 17 is a guide member that extends in the main scanning direction, as illustrated in FIG. 3 and supports the carriages 16 for sliding movement in the main scanning direction.

The main scanning motor 17a moves the height shifting mechanism 19 mounted with the carriage 16 back and forth along the main scanning guide 17 in the main scanning direction.

As illustrated in FIG. 3, the sub-scanning guide 18 extends in the sub-scanning direction on the frame 11a and supports the main scanning guide 17, allowing the main scanning guide 17 to slide in the sub-scanning direction. As illustrated in FIG. 3, two sub-scanning guide 18 are placed on two opposing sides of the frame 11a that extend in the sub-scanning direction, to support the ends of the main scanning guide 17 extending in the main scanning direction.

The sub-scanning motor 18a moves the main scanning guide 17 back and forth in the sub-scanning direction along the sub-scanning guide 18. In this case, driven by the rotation of the sub-scanning motor 18a, the timing belts 18b, which are wound around the driven pulleys, moves the main scanning guide 17 back and forth in the sub-scanning direction.

Thus, the carriage 16 mounted with the ink discharge head 16a moves freely in both the main scanning direction and the sub-scanning direction on the surface enclosed by the four sides of the frame 11a.

The height shifting mechanism 19 moves the carriages 16 back and forth in the height direction.

The support member 11b supports a base 50a of the maintenance mechanism 50, which will be described later, and secures a plate 50b to the frame 11b.

The maintenance mechanism 50 is a mechanism for performing maintenance operations such as cleaning and capping the ink discharge head 16a. As illustrated in FIG. 3, the maintaining mechanism 50 is supported by the support member 11b.

As illustrated in FIG. 3, the maintenance mechanism 50 is placed outside the printing area AR for printing using the ink discharge head 16a.

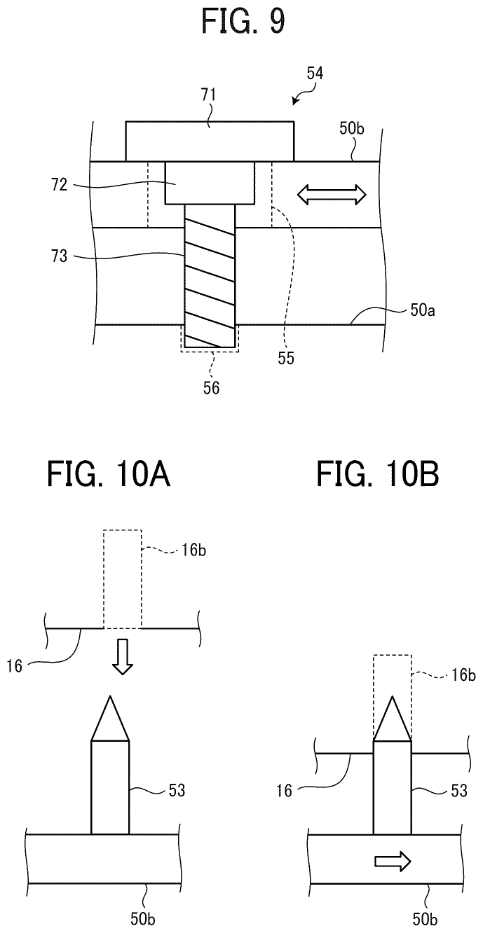

As illustrated in FIG. 3, the maintenance mechanism 50 includes a cap portion 51 (cap mechanism or simply referred to also as a cap) for capping the nozzles of the ink discharge head 16a, and a cleaner 52 (cleaning mechanism or simply referred to also as a clear) for cleaning the nozzles of the ink discharge head 16a. The details of the configuration of the maintaining mechanism 50 will be described later with reference to FIG. 9 and FIGS. 10A and 10B.

The cart 20 is a transport device used to lift the printing device 10 and from its bottom surface and transport it to a printing area for printing. As illustrated in FIG. 1, the cart 20 includes a cart frame 21, a lifting device 22, a lifting device 23, a rear wheel 24, a front wheel 25, and a handle portion 26.

The cart frame 21 is a rectangular frame (or with a rectangular shape) that supports the printing device 10 from the bottom surface during lifting and lowering.

The lifting device 22 supports the front portion of the printing device 10, which is closer to the handle portion 26 and lifts and lowers the printing device 10.

The lifting device 23 supports the rear portion of the printing device 10, located opposite the handle portion 26 and lifts and lowers the printing device 10.

The rear wheels 24 and the front wheels 25 allow the cart to move in both the front-rear direction and the right-left direction.

The handle portion 26 is attached to the front side of the cart 20 and is gripped by a user (or an operator). The user can freely move the cart 20 in the front-rear direction and the right-left direction by gripping the handle portion 26.

### Overview of Overall Operation of Liquid Application Apparatus

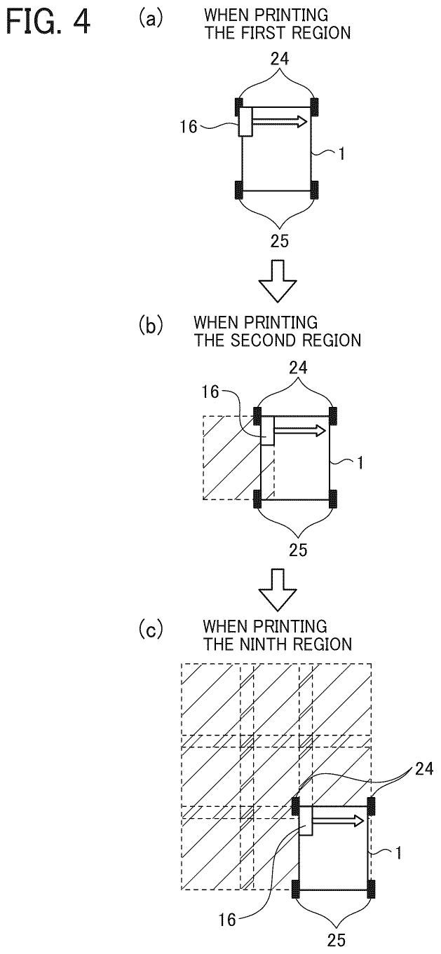

FIG. 4 is a diagram illustrating the operation of the liquid application apparatus when printing outside the scanning range of a carriage. An overview of the overall operation of a liquid application apparatus 1 will be described with reference to FIG. 4.

As described above, the liquid application apparatus 1 is movable in four directions, i.e., forward, backward, leftward, and rightward (or in the front-rear direction and the right-left direction). In other words, a carriage 16 mounted with an ink discharge head 16a is freely movable within a plane enclosed by a frame 11a of the liquid application apparatus 1.

In this configuration, the liquid application apparatus 1 operates as follows to allow the ink discharge head 16a to print on regions outside its scanning range on the printing surface. The liquid application apparatus 1 divides a liquid application area, which is an entire printing region of the printing surface, into multiple smaller printing regions; and also divides an entire printing data to be printed on the printing surface into multiple printing images, each corresponding to a specific printing region. Then, the liquid application apparatus 1 is moved backward, leftward, and rightward to each printing region over the liquid application, printing each printing image while joining the multiple printing images to minimize visible seams. Thus, the full image based on the printing data is completed.

### Moving and Lifting/Lowering Operations of a Printing Device Using a Cart

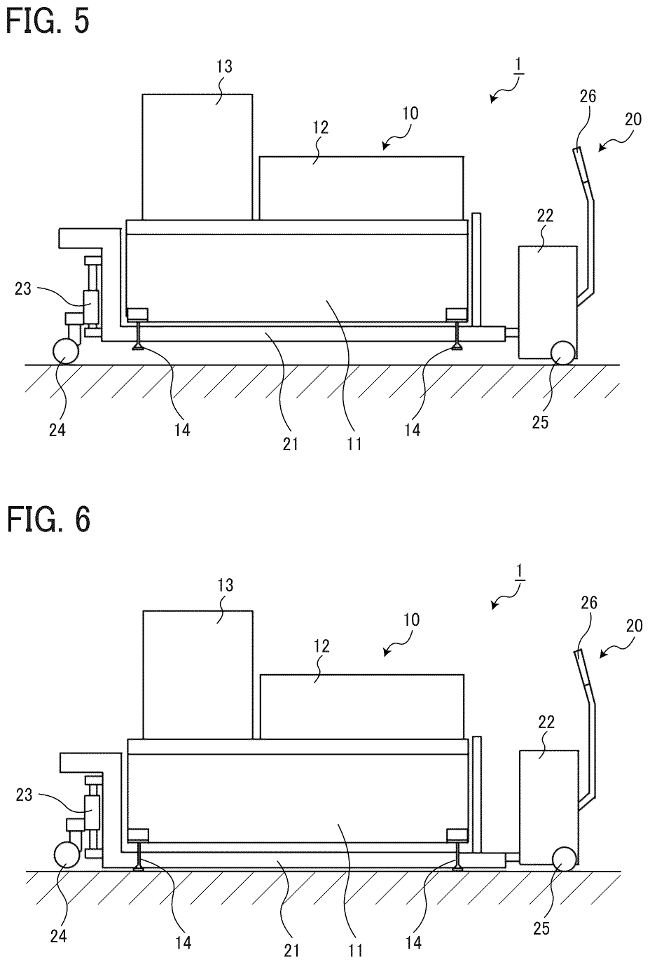

FIG. 5 is a diagram illustrating a liquid application apparatus being moved on a cart. FIG. 6 is a diagram illustrating a printing device of a liquid application apparatus, placed on a printing surface after being unloaded from a cart. The moving and lifting/lowering operations of the printing device 10 in the liquid application apparatus 1 using a cart 20 is described with reference to FIGS. 5 and 6.

In the liquid application apparatus 1 illustrated in FIG. 5, the printing device 10 is lifted up by the cart 20 and moved, with the stands 14 separated from the printing surface. With the stands 14 of the printing device 10 being separated from the printing surface, the printing device 10 can be freely moved in both the front-rear direction and the right-left direction. This allows the printing device 10 to move to a desired printing region.

In the liquid application apparatus 1 illustrated in FIG. 6, the printing device 10 is lowered by the cart 20 and supported by the stands 14 contacting the printing surface. With the printing device 10 supported by the stands 14 and fixed to the printing surface, printing can be performed by scanning the carriages 16 in the main scanning direction and the sub-scanning direction.

Although the liquid application apparatus 1 performs printing while moving relative to the printing surface, such as a road and a wall of a building, but it is not limited to this. The liquid application apparatus 1 can also be applied to typical inkjet image forming apparatuses and commercial printing machines that discharge ink from the ink discharge head 16a for printing.

### Hardware Configuration Of Liquid Application Apparatus

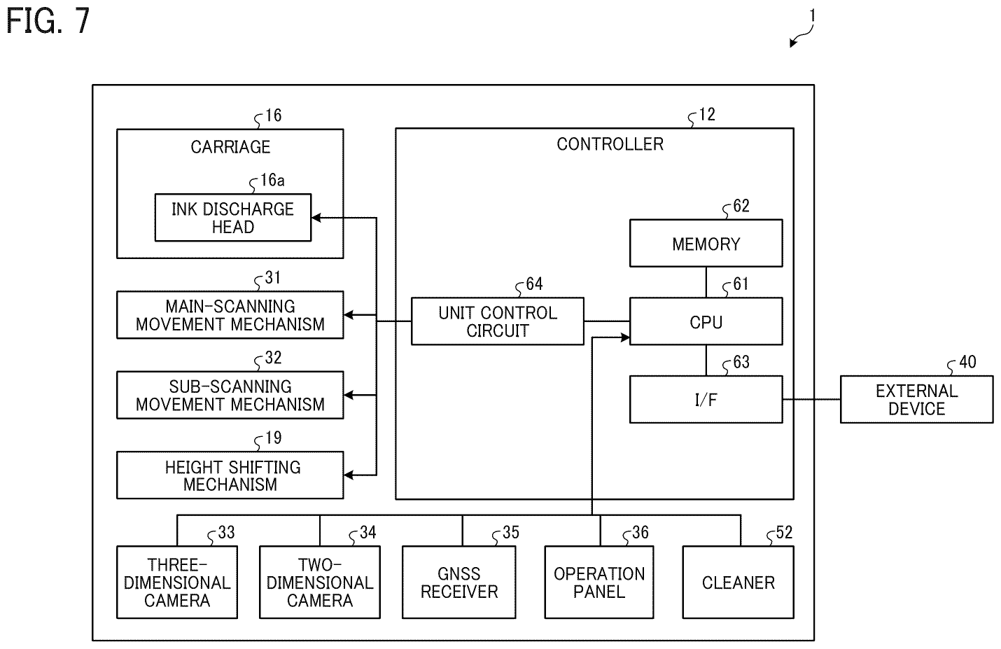

FIG. 7 is a diagram of a hardware configuration of a liquid application apparatus 1. The hardware configuration of the liquid application apparatus 1 is described below with reference to FIG. 7.

As illustrated in FIG. 7, a liquid application apparatus 1 includes a controller 12, a carriage 16, a main scanning movement mechanism 31, a sub-scanning movement mechanism 32, a height shifting mechanism 19, a three-dimensional camera 33, a two-dimensional camera 34, a global navigation satellite (GNSS) receiver 35, an operation panel 36, and a cleaner 52.

The controller 12 includes a central processing unit (CPU) 61, a memory 62, an interface (I/F63), and a unit control circuit 64.

The CPU 61 is a calculation device that integrally controls the operation of the liquid application apparatus 1. The CPU 61 is in data communication with the memory 62, the I/F 63 and the unit control circuit 64 via the bus. The CPU 61 also controls the driving of the main scanning movement mechanism 31, the sub-scanning movement mechanism 32, the height shifting mechanism 19, and an ink discharge head 16a via the unit control circuit 64, and estimates the self-position of the liquid application apparatus 1 from a position measurement signal received by the GNSS receiver 35.

The memory 62 is a storage medium, such as a read-only memory (ROM) or a random-access memory (RAM) that stores a program used to drive the CPU 61.

The memory 62 is used as a work area of the CPU 61.

The I/F 63 is a communication interface for connecting various external devices 40 such as tablet terminals, smartphones, personal computers (PCs), servers, and notebook PCs.

The unit control circuit 64 controls the operations of the main scanning movement mechanism 31, the sub-scanning movement mechanism 32, the height shifting mechanism 19, and the ink discharge head 16a under the control of the CPU 61.

A liquid application apparatus 1 includes circuitry (e.g., CPU 61) controls the second mover (e.g., a height shifting mechanism 19) to move the carriage, capped by the cap, away from the cap in the vertical direction; controls the first mover (e.g., the main scanning movement mechanism and the sub-scanning movement mechanism) to move the carriage from the first position to the second position above the cleaner; and controls the cleaner to discharge the cleaning liquid onto the nozzles of the head on the carriage at the second position.

The carriage 16 is mounted with an ink discharge head 16a that discharges ink onto the printing surface. The carriage 16 moves in the main scanning direction along the main scanning guide 17 illustrated in FIG. 3, and the main scanning guide 17 moves in the sub-scanning direction, enabling the carriage 16 to move in the sub-scanning direction. The carriage 16 is also moved in the height direction by the height shifting mechanism 19.

The three-dimensional camera 33 is a three-dimensional shape measurement device for circumference measurement. The three-dimensional camera 33 is mounted on the front portion of the printing device 10 and captures mages of the circumference of the liquid application apparatus 1. The three-dimensional camera 33 transmits the captured images to the CPU 61 of the controller 12. The three-dimensional camera 33 may be powered either by a battery mounted on the three-dimensional camera 33 or by an external power source for continuous operation.

The two-dimensional camera 34 is an imaging device that captures images of the printing surface and its surrounding area, including the printed image on the printing surface. Thus, the two-dimensional camera 34 faces downward. The two-dimensional camera 34 transmits the captured image to the CPU 61 of the controller 12. The two-dimensional camera 34 may be powered either by a battery mounted on the three-dimensional camera 33 or by an external power source for continuous operation.

The circuitry (e.g., the CPU 61) divides printing data into multiple printing images corresponding to printing regions on a printing surface; and controls the discharge head to discharge the liquid onto the printing regions on the printing surface.

The GNSS receiver 35 receives positioning signals from GNSSI from a positioning satellite based on a GNSS (for example, a global positioning system (GPS)) to measure a current position on the earth. The GNSS receiver 35 transmits the received positioning signals to the controller 12.

The operation panel 36 allows input operations for the liquid application apparatus 1 and displays its processing results.

The main scanning movement mechanism 31 includes the main scanning guide 17 and the main scanning motor 17a. The main scanning movement mechanism 31 reciprocates the carriage 16 in the main scanning direction along the main scanning guide 17 under the control of the unit control circuit 64.

The sub-scanning movement mechanism 32 includes the sub-scanning guide 18, a sub-scanning motor 18a, and a timing belt 18b. The sub-scanning movement mechanism 32 reciprocates the main scanning guide 17 on the sub-scanning guide 18 in the sub-scanning direction orthogonal to the main scanning direction under the control of the unit control circuit 64. This allows the carriage 16 supported by the main scanning guide 17 to reciprocates in the sub-scanning direction.

In other words, the main scanning movement mechanism 31 and the sub-scanning movement mechanism 32 move the carriage 16 on a horizontal plane. The main scanning movement mechanism 31 and the sub-scanning movement mechanism 32 correspond to a first movement mechanism or a first mover.

The height shifting mechanism 19 moves the carriages 16 back and forth in the height direction under the control of the unit control circuit 64. The height shifting mechanism 19 corresponds to a second movement mechanism or a second mover.

The cleaner 52 is installed in the maintenance mechanism 50 as described above, and under the control of the CPU 61, functions as a mechanism that sprays (or ejects) water or a cleaning solution containing a specified component upward to clean the nozzles of the ink discharge head 16a.

The hardware configuration of the liquid application apparatus 1 illustrated in FIG. 7 is merely an example, and the liquid application apparatus 1 may include additional components.

### Configuration and Operation of Maintenance Mechanism

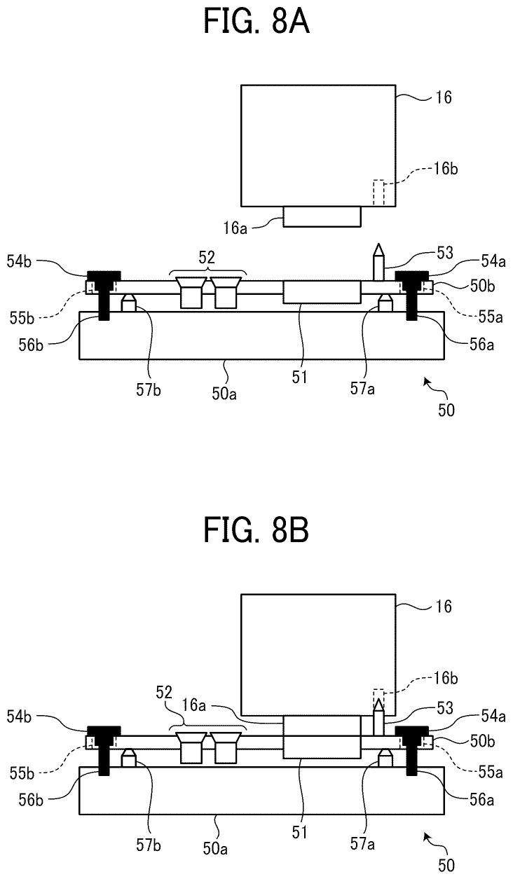

FIGS. 8A and 8B are diagrams each illustrating a configuration of a maintenance mechanism 50 of a liquid application apparatus 1. FIG. 9 is an enlarged view of a stepped screw of a maintenance mechanism 50 of a liquid application apparatus 1. FIGS. 10A and 10B are diagram illustrating an operation of inserting a pin of a carriage into a hole in a maintenance mechanism of a liquid application apparatus 1. The configuration and operation of a maintenance mechanism 50 of the liquid application apparatus 1 will be described with reference to FIGS. 8 to 10.

As illustrated in FIG. 8A, the maintenance mechanism 50 includes a base 50a, a plate 50b, a cap portion 51, a cleaner 52, a pin 53, stepped screws 54a and 54b, holes 55a and 55b, screw holes 56a and 56b, and plungers 57a and 57b.

The base 50a is a plate-shaped base member fixed to the frame 11b via the support member 11a. In other words, the base 50a is fixed to the printing device body 11.

The plate 50b is a plate-shaped member positioned facing the upper surface of the base 50a, and has a plate surface substantially parallel to the upper surface.

The cap portion 51 is a cap mechanism for capping the nozzles of the ink discharge head 16a of the lowered carriage 16. As illustrated in FIG. 8A, the cap portion 51 is installed on the plate 50b.

The cleaner 52 sprays (or ejects) water or a cleaning solution containing a specified component upward to clean the nozzles of the ink discharge head 16a. The cleaner 52 sprays (or ejects) cleaning liquid with a specific impact force distribution. Since nozzle cleaning affects the discharging performance of the ink discharge head 16a, the ink discharge head 16a is to be positioned according to this impact force distribution during the cleaning of the cleaner 52.

The pin 53 extends upward from the upper surface of the plate 50b and has a pointed tip. The pin 53 stands on the upper surface of the plate 50b. When the carriage 16 lowers to cap the nozzles with the cap portion 51, the pin 53 fits into the hole 16b in the lower surface of the carriage 16 for alignment. The inner diameter of the hole 16b is either substantially equal to the outer diameter of the pin 53 or has a clearance with the pin 53 that allows for accurate positioning.

The pin 53 and the hole 16b in the carriage 16 are examples of a guide member.

The stepped screws 54a and 54b are stepped screw members for attaching the plate 50b to the base 50a. For the stepped screws 54a and 54b, the term “stepped screw 54” is used to refer to any stepped screw or to collectively refer to the stepped screws 54a and 54b.

Regarding the holes 55a and 55b described later, the term “hole 55” is used to refer to any hole or to collectively refer to the holes 55a and 55b. Regarding the screw holes 56a and 56b described later, the term “screw hole 56” is used to refer to any hole or to collectively refer to the screw holes 56a and 56b.

As illustrated in FIG. 9, the stepped screw 54 includes a head portion 71, a stepped portion 72 having a diameter smaller than that of the head portion 71, and a threaded portion 73 having a diameter smaller than that of the stepped portion 72.

As illustrated in FIG. 9, the stepped portion 72 and the threaded portion 73 are inserted into a hole 55 formed vertically in the plate 50b, with the lower surface of the head portion 71 contacting the upper surface of the plate 50b.

Further, the threaded portion 73 screws into a threaded screw hole 56 in the upper surface of the base 50a. As will be described later, the plungers 57a and 57b press the lower surface of the plate 50b upward, pressing the peripheral edge of the hole 55 against the lower surface of the head portion 71. This secures the plate 50b to the base 50a.

However, the plate 50b is slidable on a plane (or the horizontal plane) parallel to the upper surface of the base 50a by sliding on or moving along the pressed plungers 57a and 57b and the lower surfaces of the head portion 71. In this case, as illustrated in FIG. 9, the plate 50b can slide within the diameter of the hole 55 that accommodates the stepped portion 72.

The holes 55a and 55b are vertical through-holes in the plate 50b. As illustrated in FIGS. 8A, 8B, and 9, the stepped portions 72 and the threaded portions 73 of the stepped screws 54a and 54b pass through the holes 55a and 55b, respectively.

The screw holes 56a and 56b formed in the upper surface of the base 50a and are threaded. As illustrated in FIGS. 9, 9a, and 9 B, the threaded portions 73 of the stepped screws 54a and 54b are respectively screwed into the screw holes 56a and 56b.

The plungers 57a and 57b project upward from the base 50a and apply an upward force to the lower surface of the plate 50b.

FIG. 8B illustrates the above-described maintenance mechanism 50 with the nozzles of the ink discharge head 16a capped with the cap portion 51. When the nozzles are capped by the cap 51 after printing, the main scanning movement mechanism 31 and the sub-scanning movement mechanism 32 first position the carriage 16 at a position on a horizontal plane above the cap 51 of the maintenance mechanism 50. This position on the horizontal plane is a capping position or a first position.

In a large printing device such as the liquid application apparatus 1, twisting may occur in the printing device 10 due to vibrations during movement of the printing device 10, impacts when the printing device 10 is placed on the printing surface by the stands 14, vibrations caused by scanning of the carriage 16 in the main scanning direction, the sub-scanning direction, and the height direction, or position adjustment of the carriage 16 in the height direction. As a result, the cleaning position of the ink discharge head 16a of the carriage 16, which is preset for cleaning by the cleaner 52, may deviate from the originally intended appropriate cleaning position.

The appropriate cleaning position refers to the cleaning effect by the cleaner 52 on the ink discharge head 16a at that position being optimal or preferable. As a result, the capping position of the ink discharge head 16a with respect to the cap portion 51 fixed to the plate 50b as well as the cleaner 52 also deviates from the original appropriate position.

In this case, “appropriate capping position” refers to a state in which, when the ink discharge head 16a is lowered from that position, the nozzles of the ink discharge head 16a are properly capped with the cap portion 51 so that the capping effect is optimal or suitable. Thus, when the carriage 16 is positioned at the capping position, as illustrated in FIG. 10A, the axes of the hole 16b formed in the carriage 16 and the pin 53 standing on the upper surface of the base 50a are misaligned.

When the height shifting mechanism 19 moves the carriage 16 downward from this state as illustrated in FIG. 10A, the tip portion (or end portion) of the pin 53 first enters the hole 16b, and the tapered portion of the tip portion is pushed by the peripheral edge of the hole 16b as the carriage 16 moves downward. As a result, as illustrated in FIG. 10B, the pin 53 is inserted into and fitted into the hole 16b while the plate 50b slides with respect to the base 50a. Thus, the axis of the hole 16b and the axis of the pin 53 substantially align.

As a result, as illustrated in FIG. 8B, the ink discharge head 16a is properly capped by the cap portion 51. After the plate 50b slides, the position of the plate 50b relative to the base 50a is maintained by the pressure from the plungers 57a and 57b. Then, the capping position of the ink discharge head 16a is set to an appropriate position on the horizontal plane by the sliding of the plate 50b. Thus, the cleaning position of the ink discharge head 16a is also properly set. In other words, when the ink discharge head 16a is positioned at the cleaning position (i.e., a second position) on the horizontal plane, the ink discharge head 16a is correctly aligned with the cleaner 52 to ensure proper cleaning performance.

In some examples, a pin corresponding to the pin 53 of the maintenance mechanism 50 may be formed on the lower surface of the carriage 16, and a hole corresponding to the hole 16b of the carriage 16 may be formed in the plate 50b.

### Cleaning Operation of Ink Discharge Head

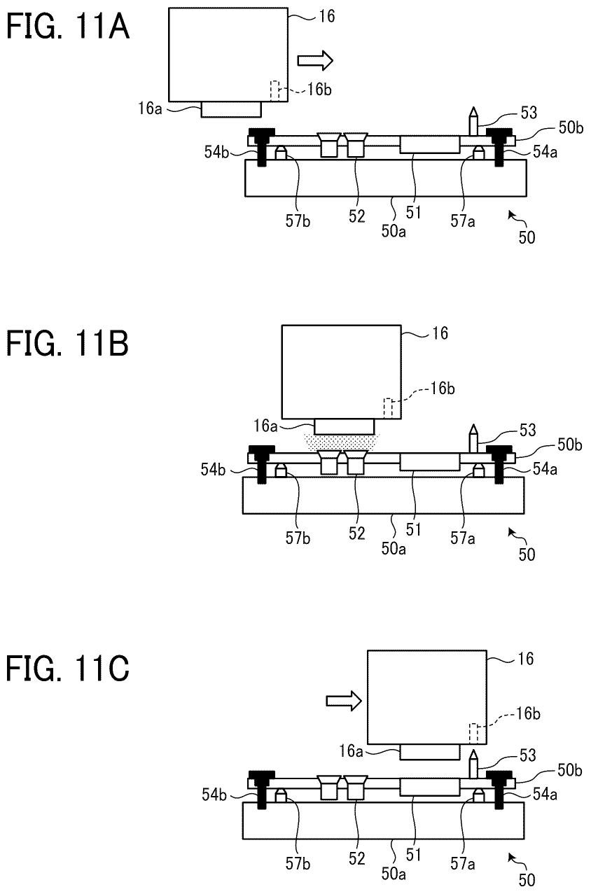

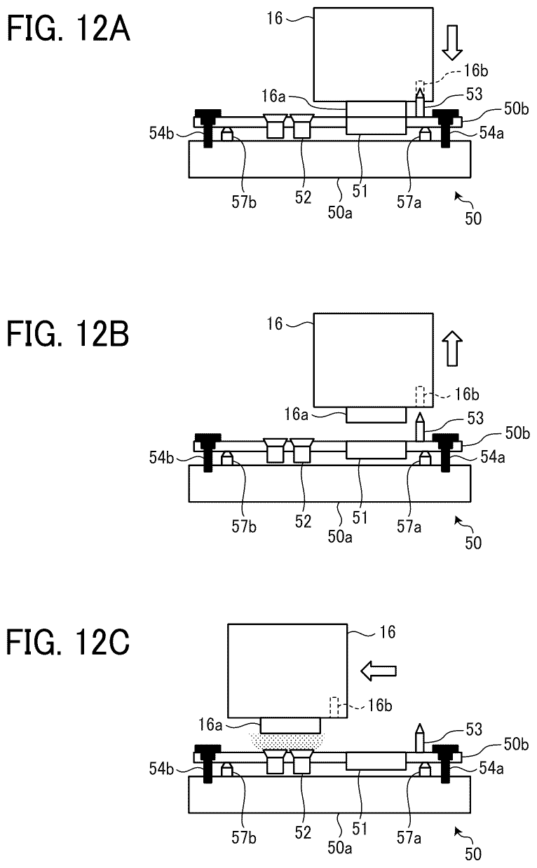

FIGS. 11A, 11B, 11C, 12A, 12B, and 12C are diagrams for describing the cleaning operations of an ink discharge head 16a of a liquid application apparatus 1. The cleaning operation flows for the ink discharge head 16a of the liquid application apparatus 1 are described with reference to FIGS. 11A, 11B, and 11C and FIGS. 12A, 12B, and 12C.

First, after the printing of the ink discharge head 16a is completed, the main scanning movement mechanism 31 and the sub-scanning movement mechanism 32 move the carriage 16 to a predefined cleaning position as illustrated in FIG. 11A. Then, as illustrated in FIG. 11B, the cleaner 52 sprays (or ejects) water or a cleaning solution containing a specified component upward to clean the nozzles of the ink discharge head 16a. At this time, the cleaning position may shift from the originally intended position due to twisting in the printing device 10 as described above.

After the cleaning of the cleaner 52 is completed, the main scanning movement mechanism 31 and the sub-scanning movement mechanism 32 move the ink discharge head 16a to a predefined capping position as illustrated in FIG. 11C. Then, as illustrated in FIG. 12A, the height shifting mechanism 19 lowers the carriage 16 from the capping position, and the pin 53 is inserted and fitted to the hole 16b of the pin 53. During this operation, the plate 50b slides relative to the base 50a so that the ink discharge head 16a can be properly capped by the cap portion 51 at an appropriate position. After the plate 50b slides, the position of the plate 50b relative to the base 50a is maintained by the pressure from the plungers 57a and 57b.

Then, when the next printing operation with the ink discharge head 16a is performed, the height shifting mechanism 19 raises the carriage 16 to release the capping state of the cap portion 51 as illustrated in FIG. 12B. The main scanning movement mechanism 31 and the sub-scanning movement mechanism 32 move the carriage 16 to a predefined cleaning position as illustrated in FIG. 12C. The cleaner 52 sprays water or a cleaning solution containing a specified component upward to the nozzles of the ink discharge head 16a of the carriage 16 at the appropriate cleaning position. At this time, the capping position of the ink discharge head 16a is set to an appropriate position by the sliding of the plate 50b as described above. Thus, the cleaning position of the ink discharge head 16a is also properly set. This results in a high cleaning effect on the nozzles of the ink discharge head 16a, maintaining the nozzles in proper condition. After that, printing with the ink discharge head 16a starts.

As described above, in the liquid application apparatus 1, the carriage 16 is mounted with the ink discharge head 16a, and the main scanning movement mechanism 31 and the sub-scanning movement mechanism 32 move the carriage 16 on a horizontal plane.

The height shifting mechanism 19 moves the carriage 16 in the height direction, and the base 50a is fixed to the body of the liquid application apparatus 1.

The plate 50b is placed between the carriage 16 and the base 50a, and slides horizontally (on the horizontal plane) relative to the upper surface of the base 50a. The cap portion 51 is mounted on the plate 50b and caps or covers the nozzles of the ink discharge head 16a.

The cleaner 52 is mounted on the plate 50b and sprays a cleaning liquid onto the nozzles. The main scanning movement mechanism 31 and the sub-scanning movement mechanism 32 moves the carriage 16 to the capping position to align the pin 53 with the hole 16b.

Upon lowering the carriage 16 from the capping position toward the cap portion 51 by the height shifting mechanism 19, the plate 50b slides horizontally (or on the horizontal plane) on the base 50a to position the nozzles for their proper capping. Specifically, the plate 50b slides on a horizontal plane with respect to the base 50a to ensure proper capping of the nozzles with the cap portion 51.

This enables automatic adjustment of the position of the ink discharge head 16a, enabling proper alignment with the cleaner 52 for its cleaning by the cleaner 52, regardless of any relative positional changes. This results in a high cleaning effect on the nozzles of the ink discharge head 16a, maintaining the nozzles in proper condition.

### First Modification

The liquid application apparatus 1 according to the first modification will be described, focusing on differences from the liquid application apparatus 1 according to the above-described embodiment. In the above-described embodiment, the pin 53 allows the plate 50b to slide relative to the base 50a. In the present modification, two pins are used to allow the plate 50b to slide relative to the base 50a. The overall configuration and hardware configuration of the liquid application apparatus 1 according to the present modification are the same as those described in the above embodiment.

### Configuration and Operation of Maintenance Mechanism

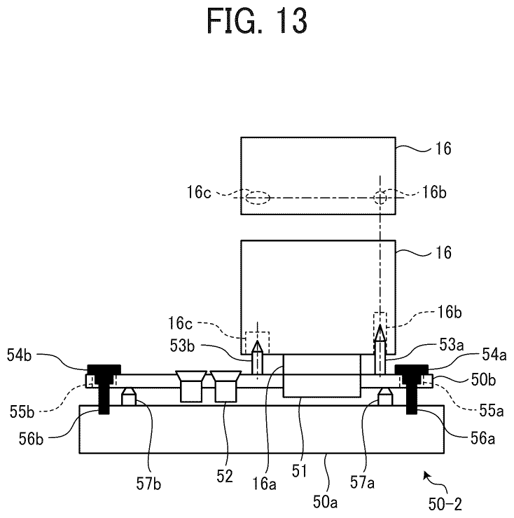

FIG. 13 is a diagram illustrating a configuration of a moving mechanism of a carriage of a liquid application apparatus according to a first modification of an embodiment of the present disclosure. The configuration and operation of a maintenance mechanism 50-2 of a liquid application apparatus 1 will be described with reference to FIG. 13.

As illustrated in FIG. 13, the maintenance mechanism 50-2 includes a base 50a, a plate 50b, a cap portion 51, a cleaner 52, pins 53a and 53b, stepped screws 54a and 54b, holes 55a and 55b, screw holes 56a and 56b, and plungers 57a and 57b. In the maintaining mechanism 50-2, the configuration, except for the pins 53a and 53b, is the same as that of the maintaining mechanism 50 in the above-described embodiment.

The pin 53a extends upward from the upper surface of the plate 50b and has a pointed tip. The pin 53a corresponds to the pin 53 of the maintaining mechanism 50 according to the above-described embodiment.

The pin 53b extends upward from the upper surface of the plate 50b and has a pointed tip. As illustrated in FIG. 13, the pin 53b and the pin 53a have different lengths in the axial direction. Specifically, the pin 53b is shorter than the pin 53a in the axial direction. The pin 53b is positioned opposite the pin 53a, with the cap portion 51 in between. In other words, the pin 53b is positioned on the opposite side of the cap portion 51 from the pin 53a.

As illustrated in FIG. 13, the carriage 16 has holes 16b and 16c in the lower surface thereof. The hole 16c is elongated, with its major axis in the direction of the line connecting the centers of the holes 16b and 16c, as illustrated in FIG. 13. The major axis of the elongated hole 16c extends along the line connecting the centers of the holes 16b and 16c. The inner diameter of the hole 16b is either substantially equal to the outer diameter of the pin 53a or has a clearance with the pin 53a that allows for accurate positioning as described above.

The pins 53a and 53band the hole 16b in the carriage 16 are examples of a guide.

FIG. 13 illustrates the above-described maintenance mechanism 50-2 with the nozzles of the ink discharge head 16a capped with the cap portion 51. When the cap portion 51 is used for capping after printing is finished, the main scanning movement mechanism 31 and the sub-scanning movement mechanism 32 first position the carriage 16 at a position on the horizontal plane (i.e., the capping position) above the cap portion 51 of the maintenance mechanism 50. When the height shifting mechanism 19 moves the carriage 16 downward from this state as illustrated in FIG. 13, the tip portion of the pin 53a longer than the pin 53b first enters the hole 16b, and the tapered portion of the tip portion is pushed by the peripheral edge of the hole 16b as the carriage 16 moves downward. Thus, the plate 50b slides with respect to the base 50a. Further, when the tip portion of the pin 53b enters the elongated hole 16c, the movement of the pin 53b is restricted along its minor axis. The pin 53a is inserted into and fitted into the hole 16b, and thus, the axis of the hole 16b and the axis of the pin 53a substantially align. Further, the direction of the line connecting the centers of the holes 16b and 16c coincides with the direction connecting the axes of the pins 53a and 53b. The ink discharge head 16a is properly capped by the cap portion 51. After the plate 50b slides, the position of the plate 50b relative to the base 50a is maintained by the pressure from the plungers 57a and 57b. Then, the position at which the cap portion 51 caps the ink discharge head 16a is set to an appropriate position on the horizontal plane by the sliding of the plate 50b. Thus, the cleaning position of the ink discharge head 16a is also properly set on the horizontal plane. In other words, when the ink discharge head 16a is positioned at the cleaning position, the ink discharge head 16a is correctly aligned with the cleaner 52 to ensure proper cleaning performance.

A liquid application apparatus includes a body; a head (e.g., ink discharge head 16a) in the body, the head to discharge a liquid from a nozzle; a carriage (e.g., a carriage 16) holding the head and movable between a first position and a second position; a base (e.g., a base 50a) fixed to the body; a plate (e.g., a plate 50b) over the base and slidable on a horizontal plane parallel to a top face of the base; a cap (e.g., a cap portion 51) on the plate, the cap to cap the nozzle of the head; a first mover (e.g., a main scanning movement mechanism 31 and a sub-scanning movement mechanism 32) to move the carriage, to the first position above the cap, on the horizontal plane; a second mover (e.g., a height shifting mechanism) to move the carriage to the cap in a vertical direction orthogonal to the horizontal plane; a cleaner (e.g., a cleaner 52) on the plate; and a guide (e.g., a pin 53 and a hole 16). The cleaner discharges a cleaning liquid onto the nozzles of the head on the carriage at the second position to clean the nozzle; and a guide to slide the plate relative to the base on the horizontal plane to guide the cap to the carriage at the first position when the second mover moves the carriage to the cap in the vertical direction.

In some examples, pins corresponding to the pins 53a and 53b of the maintenance mechanism 50-2 may be formed on the lower surface of the carriage 16, and holes corresponding to the holes 16b and 16c of the carriage 16 may be formed in the plate 50b.

### Capping Operation of Ink Discharge Head

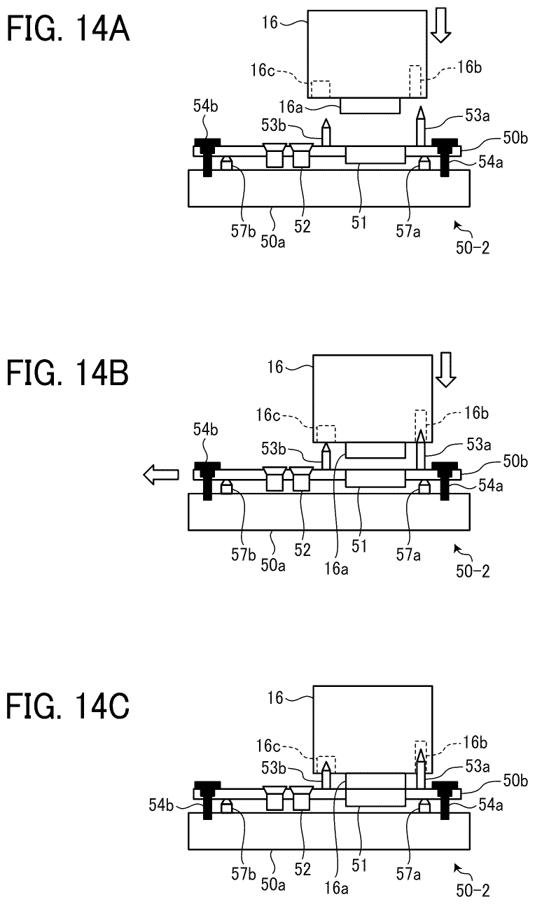

FIGS. 14A, 14B, and 14C are diagrams illustrating an operation of capping an ink discharge head 16a in a liquid application apparatus 1, according to a first modification of the above-described embodiment of the present disclosure. The capping operation of the ink discharge head 16a during cleaning in the liquid application apparatus 1 of the present modification is described below with reference to FIGS. 14A, 14B, and 14C.

After the cleaning of the cleaner 52 is completed, the main scanning movement mechanism 31 and the sub-scanning movement mechanism 32 move the ink discharge head 16a to a predefined capping position as illustrated in FIG. 14A. Then, as illustrated in FIG. 14B, the height shifting mechanism 19 lowers the carriage 16 from the capping position, and as described above, the plate 50bslides relative to the base 50a. Then, as illustrated in FIG. 14C, the pin 53a is inserted and fitted to the hole 16b, and the pin 53b is inserted and fitted to the hole 16c. The ink discharge head 16a is properly capped by the cap portion 51. After the plate 50b slides, the position of the plate 50b relative to the base 50a is maintained by the pressure from the plungers 57a and 57b.

This configuration of the present modification enables automatic adjustment of the position of the ink discharge head 16a, enabling proper alignment with the cleaner 52 for its cleaning by the cleaner 52, regardless of any relative positional changes. This results in a high cleaning effect on the nozzles of the ink discharge head 16a, maintaining the nozzles in proper condition.

### Second Modification

The liquid application apparatus 1 according to a second modification will be described, focusing on differences from the liquid application apparatus 1 according to the above-described embodiment. In the above-described embodiment, the pin 53 allows the plate 50b to slide relative to the base 50a. In the present modification, a guide member is used to allow the plate 50b to slide relative to the base 50a. The overall configuration and hardware configuration of the liquid application apparatus 1 according to the present modification are the same as those described in the above embodiment.

### Configuration and Operation of Maintenance Mechanism

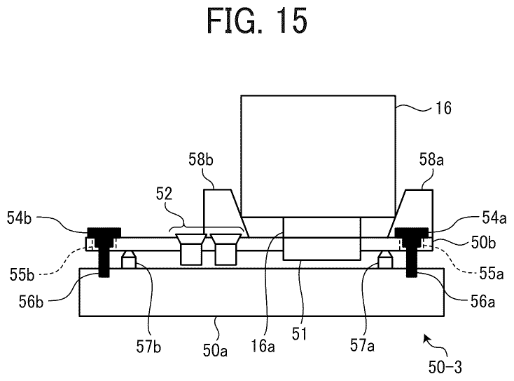

FIG. 15 is a diagram illustrating a configuration of a moving mechanism of a carriage of a liquid application apparatus according to a second modification of an embodiment of the present disclosure. The configuration and operation of a maintenance mechanism 50-3 of a liquid application apparatus 1 will be described with reference to FIG. 15.

As illustrated in FIG. 15, the maintenance mechanism 50-3 includes a base 50a, a plate 50b, a cap portion 51, a cleaner 52, stepped screws 54a and 54b, holes 55a and 55b, screw holes 56a and 56b, plungers 57a and 57b, and guide members 58a and 58b. In the maintaining mechanism 50-3, the configuration, except for the pins 53a and 53b, is the same as that of the maintaining mechanism 50 in the above-described embodiment. The maintenance mechanism 50-3 includes guide members 58a and 58b in place of the pin 53 in the maintenance mechanism 50. The carriage 16 does not have the hole 16b as in the above-described embodiment.

The guide members 58a and 58b extend upward from the opposing positions on the upper surface of the plate 50b, with the cap portion 51 interposed therebetween. The guide members 58a and 58b are tapered, with the distance between their opposing surfaces decreasing downward, as illustrated in FIG. 15. The guide members 58a and 58b are examples of a guide.

FIG. 15 illustrates the above-described maintenance mechanism 50-3 with the nozzles of the ink discharge head 16a capped with the cap portion 51. When the cap portion 51 is used for capping after printing, the main scanning movement mechanism 31 and the sub-scanning movement mechanism 32 first position the carriage 16 at a position (i.e., the capping position) above the cap portion 51 of the maintenance mechanism 50. When the height shifting mechanism 19 lowers the carriage 16 from this state, the peripheral edge of the lower surface of the carriage 16 contacts one of the opposing surfaces of the guide members 58a and 58b. The carriage 16 is then pushed by the one contacted surface toward the other opposing surface. Thus, the plate 50b slides with respect to the base 50a. The ink discharge head 16a is properly capped by the cap portion 51. After the plate 50b slides, the position of the plate 50b relative to the base 50a is maintained by the pressure from the plungers 57a and 57b.

The liquid application apparatus 1 further includes two guides (e.g., 58a, 58b), the two guides opposing on the plate, with the cap interposed therebetween. The two guides are tapered with a distance between opposing surfaces of the two guides decreasing in a direction toward the plate. When the second mover (e.g., the height shifting mechanism) moves the carriage to the cap in the vertical direction, a peripheral edge of the carriage contacts and presses one of the opposing surfaces to slide the plate relative to the base on the horizontal plane to guide the cap to the carriage at the first position.

Then, the capping position of the ink discharge head 16a is set to an appropriate position by the sliding of the plate 50b. Thus, the cleaning position of the ink discharge head 16a is also properly set. In other words, when the ink discharge head 16a is positioned at the cleaning position, the ink discharge head 16a is correctly aligned with the cleaner 52 to ensure proper cleaning performance. This results in a high cleaning effect on the nozzles of the ink discharge head 16a, maintaining the nozzles in proper condition.

In the liquid application apparatus 1 of the present modification, no holes are formed in the carriages 16, whereas the plate 50b includes the guide members 58a and 58b in place of the pin 53. This simple configuration achieves the above-described effects.

Aspects of the present disclosure are as follows.

Aspect 1

A liquid application apparatus includes a body; a head in the body, the head to discharge a liquid from a nozzle; a carriage holding the head and movable between a first position and a second position; a base fixed to the body; a plate over the base and slidable on a horizontal plane parallel to a top face of the base; a cap on the plate, the cap to cap the nozzle of the head; a first mover to move the carriage, to the first position above the cap, on the horizontal plane; a second mover to move the carriage to the cap in a vertical direction orthogonal to the horizontal plane; a cleaner on the plate, the cleaner to discharge a cleaning liquid onto the nozzles of the head on the carriage at the second position to clean the nozzle; and a guide to slide the plate relative to the base on the horizontal plane to guide the cap to the carriage at the first position when the second mover moves the carriage to the cap in the vertical direction.

Aspect 2

The liquid application apparatus according to Aspect 1, further includes circuitry (e.g., CPU 61) controls the second mover to move the carriage, capped by the cap, away from the cap in the vertical direction; controls the first mover to move the carriage from the first position to the second position above the cleaner; and controls the cleaner to discharge the cleaning liquid onto the nozzle of the head on the carriage at the second position.

Aspect 3

In the liquid application apparatus according to Aspect 1 or 2, the guide includes a pin having a tip portion, the pin standing on the plate; and a hole in the carriage, the hole into which the pin is insertable.

Aspect 4

In the liquid application apparatus according to Aspect 1 or 1, the guide includes a pin having a tip portion, the pin standing on a face of the carriage; and a hole in the plate, the hole into which the pin is insertable.

Aspect 5

In the liquid application apparatus according to Aspect 1 or 2, the guide includes two pins each having a tip portion, the two pins standing on the plate; and two holes in the carriage, the two holes into which the two pins are respectively insertable.

Aspect 6

In the liquid application apparatus according to Aspect 1 or 2, the guide includes two pins each having a tip portion, the two pins standing on the carriage; and two holes in the plate, the two holes into which the two pins are respectively insertable.

Aspect 7

In the liquid application apparatus according to Aspect 5 or 6, the two holes have a circular hole having a first center; and an elongated hole having a second center along a major axis. The major axis coincides with a line connecting the first center and the second center.

Aspect 8

In the liquid application apparatus according to Aspect 5 or 6, the two pins have different length in an axial direction thereof.

Aspect 9

The liquid application apparatus according to Aspect 1 or 2, further includes two guides including the guide, the two guides opposing on the plate, with the cap interposed therebetween. The two guides are tapered with a distance between opposing surfaces of the two guides decreasing in a direction toward the plate. When second mover moves the carriage to the cap in the vertical direction, a peripheral edge of the carriage contacts and presses one of the opposing surfaces to slide the plate relative to the base on the horizontal plane to guide the cap to the carriage at the first position.

Aspect 10

The liquid application apparatus according to any one of Aspects 1 to 9, further includes circuitry (e.g., the CPU 61) divides printing data into multiple printing images corresponding to printing regions on a printing surface; and controls the discharge head to discharge the liquid onto the printing regions on the printing surface.

Aspect 11

In the liquid application apparatus according to Aspect 1, the first mover moves the carriage between the first position and the second position in a main scanning direction on the horizontal plane; and moves the carriage in a sub-scanning direction orthogonal to the main scanning direction on the horizontal plane.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid application apparatus comprising:
a body;
a head in the body, the head to discharge a liquid from a nozzle;
a carriage holding the head and movable between a first position and a second position;
a base fixed to the body;
a plate over the base and slidable on a horizontal plane parallel to a top face of the base;
a cap on the plate, the cap to cap the nozzle of the head;
a first mover to move the carriage, to the first position above the cap, on the horizontal plane;
a second mover to move the carriage to the cap in a vertical direction orthogonal to the horizontal plane;
a cleaner on the plate, the cleaner to discharge a cleaning liquid onto the nozzles of the head on the carriage at the second position to clean the nozzle; and
a guide to slide the plate relative to the base on the horizontal plane to guide the cap to the carriage at the first position when the second mover moves the carriage to the cap in the vertical direction.

2. The liquid application apparatus according to claim 1, further comprising circuitry configured to:
control the second mover to move the carriage, capped by the cap, away from the cap in the vertical direction;
control the first mover to move the carriage from the first position to the second position above the cleaner; and
control the cleaner to discharge the cleaning liquid onto the nozzle of the head on the carriage at the second position.

3. The liquid application apparatus according to claim 1,
wherein the guide includes:
a pin having a tip portion, the pin standing on the plate; and
a hole in the carriage, the hole into which the pin is insertable.

4. The liquid application apparatus according to claim 1,
wherein the guide includes:
a pin having a tip portion, the pin standing on a face of the carriage; and
a hole in the plate, the hole into which the pin is insertable.

5. The liquid application apparatus according to claim 1,
wherein the guide includes:
two pins each having a tip portion, the two pins standing on the plate; and
two holes in the carriage, the two holes into which the two pins are respectively insertable.

6. The liquid application apparatus according to claim 1,
wherein the guide includes:
two pins each having a tip portion, the two pins standing on the carriage; and
two holes in the plate, the two holes into which the two pins are respectively insertable.

7. The liquid application apparatus according to claim 5,
wherein the two holes have:
a circular hole having a first center; and
an elongated hole having a second center along a major axis, and
the major axis coincides with a line connecting the first center and the second center.

8. The liquid application apparatus according to claim 5, wherein
the two pins have different length in an axial direction thereof.

9. The liquid application apparatus according to claim 1, further comprising two guides including the guide, the two guides opposing on the plate, with the cap interposed therebetween, the two guides being tapered with a distance between opposing surfaces of the two guides decreasing in a direction toward the plate, wherein
when the second mover moves the carriage to the cap in the vertical direction, a peripheral edge of the carriage contacts and presses one of the opposing surfaces to slide the plate relative to the base on the horizontal plane to guide the cap to the carriage at the first position.

10. The liquid application apparatus according to claim 1, further comprising circuitry configured to:
divide printing data into multiple printing images corresponding to printing regions on a printing surface; and
control the head to discharge the liquid onto the printing regions on the printing surface.

11. The liquid application apparatus according to claim 1,
wherein the first mover:
moves the carriage between the first position and the second position in a main scanning direction on the horizontal plane; and
moves the carriage in a sub-scanning direction orthogonal to the main scanning direction on the horizontal plane.
